(19) United States
(12) Patent Application Publication
(10) Pub. No.: US 2024/0265098 A1
(43) Pub. Date: Aug. 8, 2024

(54) MONITORING AREA DETERMINATION APPARATUS, MONITORING AREA DETERMINATION METHOD, AND COMPUTER READABLE MEDIUM

(71) Applicant: NEC Corporation, Minato-ku, Tokyo (JP)

(72) Inventors: Yuto HAYAKI, Tokyo (JP); Norio YAMAGAKI, Tokyo (JP)

(73) Assignee: NEC Corporation, Minato-ku, Tokyo (JP)

(21) Appl. No.: 18/567,137

(22) PCT Filed: Jun. 9, 2021
(86) PCT No.: PCT/JP2021/021859

§ 371 Date: Dec. 5, 2023

(51) Int. Cl. G06F 21/55

(52) U.S. Cl. CPC G06F 21/552; G06F 2221/033

(57) ABSTRACT

The present disclosure relates to a monitoring area determination apparatus that determines, for software to be monitored, a monitoring area of a tampering detection feature call function (hook) incorporated together with a tampering detection feature. The apparatus generates a CFG based on a binary of the software, temporarily determines, based on the CFG, a part of a source code of the software into which a hook is incorporated and temporarily determines, based on the CFG, in accordance with a predetermined rule, a monitoring area of the hook whose incorporated part is temporarily determined, sequentially selects the hook whose incorporated part has been temporarily determined, adds a node to the temporarily-determined monitoring area of the selected hook based on a predetermined allowable processing delay, and determines, as the monitoring area of the selected hook, a monitoring area after the node is added to the temporarily-determined monitoring area of the selected hook.

### TECHNICAL FIELD

The present disclosure relates to a monitoring area determination apparatus, a monitoring area determination method, and a computer readable medium for determining a monitoring area monitored by a tampering detection feature call function for calling a tampering detection feature, and in particular, to a monitoring area determination apparatus, a monitoring area determination method, and a computer readable medium used for software of devices such as Internet of Things (IoT) devices.

### BACKGROUND ART

In recent years, IoT devices have been widely used. As a result, there has been a demand for a security system that operates even in a device such as an IoT device that does not have a sufficiently large number of resources such as a memory or a Central Processing Unit (CPU).

As a related security system, a method in which an allowed-list-type tampering detection feature using hash values is incorporated into a device to monitor whether or not software in the device is in a correct state (whether or not it is tampered with) has been known.

The allowed-list-type tampering detection feature using hash values is a feature in which information on a memory of the device in a normal state is registered in an allowed list in advance, information on the memory of the device during the operation of the device is compared with information on the memory registered in the allowed list, and the presence or absence of tampering is monitored. At this time, the information on the memory is managed in a form of hash values.

The allowed-list-type tampering detection feature using hash values is implemented as follows. First, information on a memory of a device in a normal state is acquired by a desired method in advance and the acquired information on the memory is registered in an allowed list. The information on the memory indicates how an execution code is deployed in the memory. Next, the information on the memory is acquired at a desired timing during the operation of the device, and the acquired information on the memory is compared with the information on the memory registered in the allowed list. If, as a result of the comparison, it is found that the information on the memory acquired while the device is being operated coincides with the information on the memory registered in the allowed list, it means that the device has not been tampered with (it is not attacked). If they do not coincide with each other, it means that the device is tampered with (it has been attacked).

The allowed list means snapshots of a memory in a normal state. However, registering and comparing hash values has less impact on the original operation of the device than registering and comparing snapshots of the memory in its original form do. Therefore, information on the memory in the normal state is registered in the allowed list in the form of hash values, and information on the memory during the operation is also managed in the form of hash values. Non-Patent Literature 1 and 2 disclose examples of an allowed-list-type tampering detection feature using hash values.

Non-Patent Literature 1 discloses a method for detecting, when triggered by an input to a device, tampering of a function that is to be executed. According to the method in Non-Patent Literature 1, a function that is to be executed (in this example, this function will be called a “function A”) is determined by user input. Further, a tampering detection feature call function for calling the tampering detection feature is started by user input. The tampering detection feature call function calls for the tampering detection feature, limits the memory area used when the function A is executed to the monitoring area, and monitors the presence or absence of tampering in the monitoring area.

Non-Patent Literature 2 discloses a method for setting a monitoring area in monitoring at one time as one node of a control flow graph (CFG) to achieve monitoring whose speed is higher than that in the method in Non-Patent Literature 1. Here, the CFG is a graph indicating an order in which programs are executed. Therefore, the CFG is a directed graph. Nodes of the CFG are execution codes for successive programs. At this time, one node of a CFG is divided into blocks for each branch command, and each block is called a basic block. That is, it can be said that one node of the CFG is one basic block.

Now, with reference to FIG. 1, examples of the source code and the CFG will be described. The right side of FIG. 1 shows the source code and the left side of FIG. 1 shows the CFG generated based on a binary in which the source code on the right side is built. Further, the numbers in each node on the left side of FIG. 1 show row numbers of the source code on the right side, and each node includes execution codes that correspond to the row numbers shown by the numbers in each node. For example, the node 2 includes execution codes that correspond to the sixth and seventh rows of the source code.

Further, with reference to FIGS. 2 and 3, examples of a source code into which tampering detection feature call functions (hereinafter “hooks” as appropriate) are incorporated and a CFG will be described. FIG. 2 shows a source code in which hooks are incorporated into the source code shown in FIG. 1, and FIG. 3 shows a CFG generated based on a binary in which the source code shown in FIG. 2 is built. In the examples shown in FIGS. 2 and 3, a hook H1 is incorporated just before the node 1 and the monitoring area of the hook H1 is nodes 1 and 3. Further, hooks H2, H4, H5, and H6 are respectively incorporated just before nodes 2, 4, 5, and 6, and monitoring areas of the hooks H2, H4, H5, and H6 are respectively the nodes 2, 4, 5, and 6. While the hooks H1, H2, H4, H5, and H6 are incorporated just before the nodes 1, 2, 4, 5, and 6 as independent nodes in the examples shown in FIGS. 2 and 3, they may be incorporated into the top of the nodes 1, 2, 4, 5, and 6 or may be incorporated in the middle of the nodes 1, 2, 4, 5, and 6.

### CITATION LIST

### Patent Literature

[Non-Patent Literature 1] Toshiki Kobayashi, Takayuki Sasaki, Astha Jada, Daniele E. Asoni, Adrian Perrig, “SAFES: Sand-boxed Architecture for Frequent Environment Self-measurement”, Proceedings of the 3rd Workshop on System Software for Trusted Execution, 2018, pp. 37-41
[Non-Patent Literature 2] Yuto Hayaki, Takayuki Sasaki, Seng Pei Liew, Koki Tomita, Norio Yamagaki, “Proposal of proof of trust by tampering detection system for IoT devices”, SCIS2020, 2020, pp. 1-6

### SUMMARY OF INVENTION

### Technical Problem

As described above, information on a memory is registered in the allowed list in a form of hash values. More specifically, for each hook, a set of an ID of the hook, a monitoring area of the hook, and a hash value of the monitoring area is registered in the allowed list.

Therefore, when the number of monitoring areas increases, the size of the allowed list increases. When, for example, one hook monitors one node (basic block) in monitoring at one time, the size of the allowed list becomes maximum. The size of the allowed list Size_{whitelist} in this case may be expressed by the following Expression 1.

$${Size}_{whitelist} = {Num}_{basic block} \times ( identifier + {Addr}_{start} + {Addr}_{end} + hashvalue ) \qquad [ Expression 1 ]$$

In Expression 1, Num_{basic block} denotes the number of nodes (basic blocks). Further, “identifer” denotes the size of the ID of the hook. Further, Addrₛₜₐᵣₜ denotes the size of a starting point address of the monitoring area and Addr_{end} denotes the size of an ending point address of the monitoring area. Further, “hashvalue” denotes the size of the hash value of the monitoring area (32 bytes for SHA-256). While Expression 1 shows the monitoring area by a set of a starting point address and an ending point address, the monitoring area may be expressed by a set of a starting point address and an address range (a range from the starting point address to the ending point address). In this case, Expression 1 may replace the size of the ending point address of the monitoring area by the size of the address range of the monitoring area. Further, of the parameters in ( ) in Expression 1, the hash value has the largest size.

Here, the size of the allowed list can be reduced by grouping monitoring areas. The size of the allowed list Size_{whitelist} in a case where monitoring areas are grouped may be expressed by the following Expression 2.

$${Size}_{whitelist} = {Num}_{check} \times [ identifier + {\sum }_{{Num}_{check}} ( {Addr}_{start} + {Addr}_{end} ) + hashvalue ] \qquad [ Expression 2 ]$$

In Expression 2, Num_{check} denotes the number of monitoring areas.

Expression 2 is different from Expression 1 in that the number of IDs of the hook is reduced and the number of hash values having a large size is reduced in Expression 2. Therefore, the size of the allowed list calculated in Expression 2 is reduced more than the size of the allowed list calculated in Expression 1.

Assume a case, for example, where one hook monitors one node (basic block) when there are 10 nodes (basic blocks) on the CFG. Then, the size of the allowed list Size_{whitelist} is expressed by the following Expression 3 according to Expression 1.

$${Size}_{whitelist} = 10 \times ( identifier + 2 Addr + hashvalue ) \qquad [ Expression 3 ]$$

On the other hand, assume a case where nodes are grouped so that each group includes two nodes (basic blocks) and one hook monitors two nodes (basic blocks) when there are 10 nodes (basic blocks) on the CFG. Then, the size of the allowed list Size_{whitelist} is expressed by the following Expression 4 according to Expression 2.

$${Size}_{whitelist} = 5 \times ( identifier + 4 Addr + hashvalue ) \qquad [ Expression 4 ]$$

By grouping the monitoring areas as described above, the size of the allowed list can be reduced.

However, it is possible that simply grouping the monitoring areas to reduce the size of the allowed list may cause an increase in a processing delay of tampering detection processing.

In order to solve the aforementioned problem, an aim of the present disclosure is to provide a monitoring area determination apparatus, a monitoring area determination method, and a computer readable medium capable of determining a monitoring area of a tampering detection feature call function in such a way that a processing delay of tampering detection processing falls within an appropriate range while reducing the size of an allowed list.

### Solution to Problem

A monitoring area determination apparatus according to one aspect of the present disclosure is a monitoring area determination apparatus configured to determine, for software to be monitored, a monitoring area of a tampering detection feature call function incorporated together with a tampering detection feature, the monitoring area determination apparatus including: a CFG generation unit configured to generate a control flow graph (CFG) based on a binary of the software; and a monitoring area determination unit, in which the monitoring area determination unit temporarily determines, based on the CFG, a part of a source code of the software into which the tampering detection feature call function is incorporated, and temporarily determines, in accordance with a predetermined rule, based on the CFG, a monitoring area of the tampering detection feature call function whose incorporated part is temporarily determined, the monitoring area determination unit sequentially selects the tampering detection feature call function whose incorporated part has been temporarily determined, the monitoring area determination unit adds a node to the temporarily-determined monitoring area of the selected tampering detection feature call function based on a predetermined allowable processing delay, and the monitoring area determination unit determines, as a monitoring area of the selected tampering detection feature call function, a monitoring area after the node is added to the temporarily-determined monitoring area of the selected tampering detection feature call function.

A monitoring area determination method according to another aspect of the present disclosure is a monitoring area determination method executed by a monitoring area determination apparatus configured to determine, for software to be monitored, a monitoring area of a tampering detection feature call function incorporated together with a tampering detection feature, the monitoring area determination method including the steps of: generating a control flow graph (CFG) based on a binary of the software: temporarily determining, based on the CFG, a part of a source code of the software into which the tampering detection feature call function is incorporated and temporarily determining, in accordance with a predetermined rule, based on the CFG, a monitoring area of the tampering detection feature call function whose incorporated part is temporarily determined: sequentially selecting the tampering detection feature call function whose incorporated part has been temporarily determined: adding a node to the temporarily-determined monitoring area of the selected tampering detection feature call function based on a predetermined allowable processing delay; and determining, as a monitoring area of the selected tampering detection feature call function, a monitoring area after the node is added to the temporarily-determined monitoring area of the selected tampering detection feature call function.

A computer readable medium according to yet another aspect of the present disclosure is a non-transitory computer readable medium storing a program causing a computer to execute processing for determining, for software to be monitored, a monitoring area of a tampering detection feature call function incorporated together with a tampering detection feature, in which the program includes the steps of: generating a control flow graph (CFG) based on a binary of the software: temporarily determining, based on the CFG, a part of a source code of the software into which the tampering detection feature call function is incorporated and temporarily determining, in accordance with a predetermined rule, based on the CFG, a monitoring area of the tampering detection feature call function whose incorporated part is temporarily determined: sequentially selecting the tampering detection feature call function whose incorporated part has been temporarily determined: adding a node to the temporarily-determined monitoring area of the selected tampering detection feature call function based on a predetermined allowable processing delay; and determining, as a monitoring area of the selected tampering detection feature call function, a monitoring area after the node is added to the temporarily-determined monitoring area of the selected tampering detection feature call function.

### Advantageous Effects of Invention

The aforementioned aspects achieve an effect that it is possible to provide a monitoring area determination apparatus, a monitoring area determination method, and a computer readable medium capable of determining a monitoring area of a tampering detection feature call function in such a way that a processing delay of tampering detection processing falls within an appropriate range while reducing the size of an allowed list.

### BRIEF DESCRIPTION OF DRAWINGS

FIG. 1 is a diagram showing examples of a source code and a CFG;

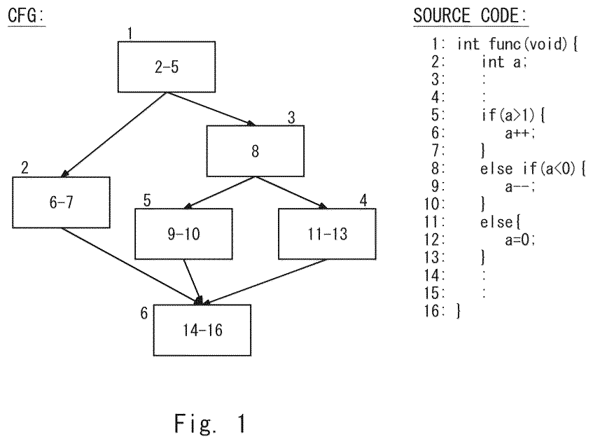

FIG. 2 is a diagram showing an example of a source code in which tampering detection feature call functions are incorporated into the source code shown in FIG. 1:

FIG. 3 is a diagram showing an example of a CFG generated based on the source code shown in FIG. 2: FIG. 4 is a block diagram showing a configuration example of a monitoring area determination apparatus according to a first example embodiment:

FIG. 5 is a diagram for describing a specific example of a determination method in which an allowed list creation unit according to the first example embodiment determines a part into which a hook is incorporated and a monitoring area of this hook;

FIG. 6 is a diagram for describing an example of a predetermined policy that the allowed list creation unit according to the first example embodiment uses to determine the monitoring area of the hook;

FIG. 7 is a flowchart for describing an overall operation example of the monitoring area determination apparatus according to the first example embodiment;

FIG. 8 is a flowchart for describing an operation example that the allowed list creation unit according to the first example embodiment performs in Step A4 in FIG. 7;

FIG. 9 is a flowchart for describing an operation example that the allowed list creation unit according to the first example embodiment performs in Step B4 in FIG. 8;

FIG. 10 is a diagram showing examples of parts where hooks are incorporated, temporarily determined by the allowed list creation unit according to the first example embodiment, and its monitoring areas (monitoring nodes);

FIG. 11 is a block diagram showing a configuration example of a monitoring area determination apparatus according to a second example embodiment; and

FIG. 12 is a block diagram showing a hardware configuration example of a monitoring area determination apparatus according to a third example embodiment.

### EXAMPLE EMBODIMENT

Hereinafter, with reference to the drawings, example embodiments of the present disclosure will be described. In the following example embodiments, the same or equivalent elements are denoted by the same reference symbols and redundant descriptions will be omitted. Further, a monitoring area determination apparatus described in each of the following example embodiments is an example of an apparatus that determines, for software to be monitored, a monitoring area of tampering detection feature call functions (hooks) incorporated together with an allowed-list-type tampering detection feature using hash values.

### First Example Embodiment

### Configuration of First Example Embodiment

Referring first to FIG. 4, a configuration example of a monitoring area determination apparatus 100 according to a first example embodiment will be described. In FIG. 4, unidirectional arrows are intended to simply indicate directions of a flow of certain data (or signals, information, etc.), and do not exclude bidirectionality.

Referring to FIG. 4, the monitoring area determination apparatus 100 according to the first example embodiment includes an input/output unit 101, a build unit 102, a Control Flow Graph (CFG) generation unit 103, an allowed list creation unit 104, and a storage unit 105.

The above components operate as follows.

A source code of software to be monitored, that is, a source code of software into which a tampering detection feature is incorporated, is input to the input/output unit 101. The software to be monitored is, for example, control software or the like on an IoT device. The input/output unit 101 causes the storage unit 105 to store the input source code, and sends a notification to the build unit 102 to cause the build unit 102 to perform processing.

Further, upon receiving a notification that will be described later from the allowed list creation unit 104, the input/output unit 101 reads out a binary of software into which a tampering detection feature and hooks that will be described later are incorporated (hereinafter, this binary will be referred to as a “tampering detection feature incorporated binary”) from the storage unit 105, and outputs the tampering detection feature incorporated binary that has been read out. Further, the input/output unit 101 reads out an allowed list that will be described later from the storage unit 105, and outputs the allowed list that has been read out along with the tampering detection feature incorporated binary. However, the input/output unit 101 is not limited to reading out the tampering detection feature incorporated binary and the allowed list from the storage unit 105. The input/output unit 101 may receive the tampering detection feature incorporated binary from the build unit 102 or may receive the allowed list from the allowed list creation unit 104.

Upon receiving the notification from the input/output unit 101, the build unit 102 reads out the source code from the storage unit 105 and performs building. The build unit 102 causes the storage unit 105 to store a binary generated by building and sends a notification to the CFG generation unit 103 to cause the CFG generation unit 103 to perform processing.

Further, upon receiving a notification that will be described later from the allowed list creation unit 104, the build unit 102 reads out a source code into which a tampering detection feature and hooks that will be described later are incorporated (hereinafter this source code will be referred to as a “tampering detection feature incorporated source code”) from the storage unit 105, and performs building. The build unit 102 causes the storage unit 105 to store the tampering detection feature incorporated binary generated by building.

Upon receiving the notification from the build unit 102, the CFG generation unit 103 reads out a binary from the storage unit 105, analyzes the binary that has been read out, and generates a CFG. The CFG generation unit 103 sends the CFG generated from the binary to the allowed list creation unit 104.

Upon receiving the CFG from the CFG generation unit 103, the allowed list creation unit 104 determines, based on the CFG, for each hook incorporated into the source code, a part of the source code into which this hook is incorporated, and determines a monitoring area of this hook.

Further, the allowed list creation unit 104 incorporates the respective hooks into the parts of the source code determined above, and incorporates the tampering detection feature into the source code. The entire source code in which the hooks and the tampering detection feature are thus incorporated is a tampering detection feature incorporated source code. The allowed list creation unit 104 causes the storage unit 105 to store the tampering detection feature incorporated source code. Further, after the allowed list creation unit 104 causes the storage unit 105 to store the tampering detection feature incorporated source code, the allowed list creation unit 104 sends a notification to the build unit 102 to cause the built part 102 to perform processing.

Further, the allowed list creation unit 104 creates, for each hook, an allowed list in which a set of an ID of this hook, a monitoring area of this hook, and a hash value of the monitoring area are registered and causes the allowed list that has been created to be stored in the storage unit 105. Further, after the allowed list creation unit 104 causes the allowed list to be stored in the storage unit 105, the allowed list creation unit 104 sends a notification to the input/output unit 101 to cause the input/output unit 101 to perform processing.

The storage unit 105 stores the source code received from the input/output unit 101, the allowed list and the tampering detection feature incorporated source code received from the allowed list creation unit 104, and the binary and the tampering detection feature incorporated binary received from the build unit 102.

Note that the storage unit 105 is not a component that is absolutely necessary in the monitoring area determination apparatus 100, and may be provided in the outside of the monitoring area determination apparatus 100. That is, the monitoring area determination apparatus 100 may be composed of minimum components including the input/output unit 101, the build unit 102, the CFG generation unit 103, and the allowed list creation unit 104.

Next, an outline of a determination method for determining parts into which hooks are incorporated and the monitoring areas of the respective hooks in the allowed list creation unit 104 will be described.

In tampering detection processing, an allowable processing delay that is allowed when a hook performs monitoring at one time is set in advance. The allowed list creation unit 104 determines the monitoring area of the hook based on the allowable processing delay. While the processing delay of the tampering detection processing includes a processing delay due to reading of a memory and calculation of hash values, a time required to read the memory and a time required to calculate the hash values can be estimated from a past history or the like.

First, the allowed list creation unit 104 temporarily determines, based on the CFG, the part into which the hook is incorporated, and temporarily determines, in accordance with a predetermined rule based on the CFG, the monitoring area of this hook whose incorporated part is temporarily determined (Procedure 1).

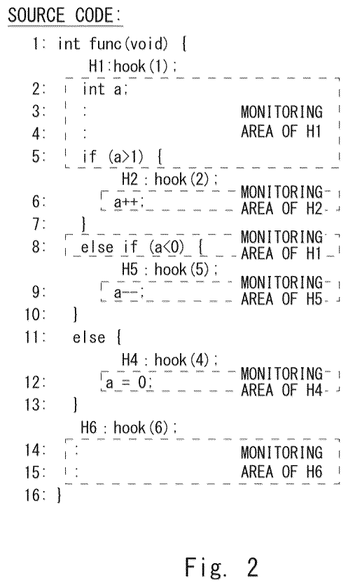

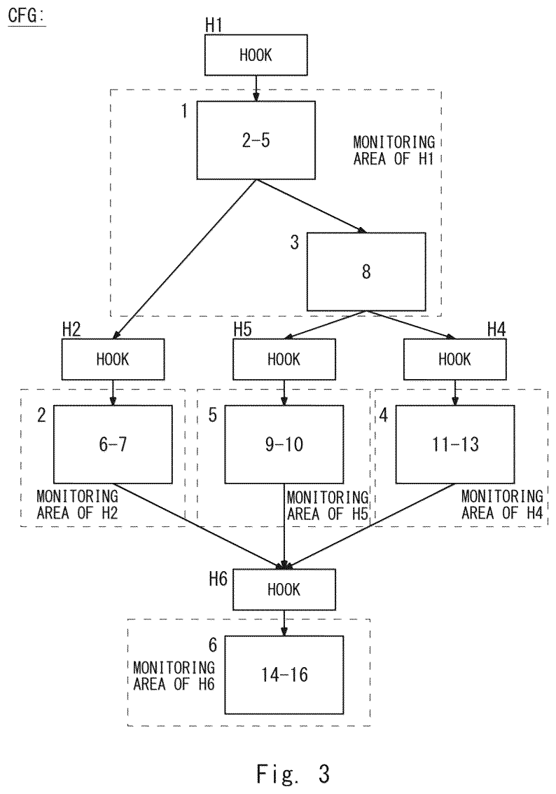

For example, the predetermined rule may be a rule in which a node including this hook is added to the monitoring area of this hook. In the examples shown in FIGS. 2 and 3, for example, when this hook is a hook H1, the node that includes the hook H1 is a node 1. Therefore, the allowed list creation unit 104 adds the node 1 that includes the hook H1 to the monitoring area of the hook H1.

Alternatively, the predetermined rule may be a rule in which, of all the descendant nodes of the node including this hook, nodes that do not include hooks are traced, and nodes from the node including this hook to a node just before a node including the next hook are added to the monitoring area of this hook. In the examples shown in FIGS. 2 and 3, for example, when this hook is a hook H1, the node that includes the hook H1 is a node 1. Further, of the descendent nodes of the node 1, nodes that do not include hooks is a node 3. Therefore, while the allowed list creation unit 104 traces the node 3, nodes 4 and 5, which are child nodes of the node 3, respectively include hooks H4 and H5. Therefore, the allowed list creation unit 104 adds the node 1 that includes the hook H1, and the node 3 to the monitoring area of the hook H1.

Next, the allowed list creation unit 104 sequentially selects the hook whose incorporated part has been temporarily determined, and adds another monitoring area (node) to the temporarily-determined monitoring area of the selected hook based on a predetermined allowable processing delay. More specifically, the allowed list creation unit 104 compares the size of the temporarily-determined monitoring area of the selected hook with the size derived from the predetermined allowable processing delay (hereinafter this size will be referred to as a “threshold size”). When the size of the temporarily-determined monitoring area of this hook is equal to or smaller than a threshold size, the allowed list creation unit 104 adds another monitoring area (node) to the temporarily-determined monitoring area of this hook in accordance with a predetermined policy in such a way that the size of the monitoring area does not exceed the threshold size. Then, the allowed list creation unit 104 determines the monitoring area after the other monitoring area (node) is added to the temporarily-determined monitoring area of this hook to be the monitoring area of the hook. Further, the allowed list creation unit 104 determines to delete the hook temporarily determined to monitor the other monitoring area (node) (Procedure 2).

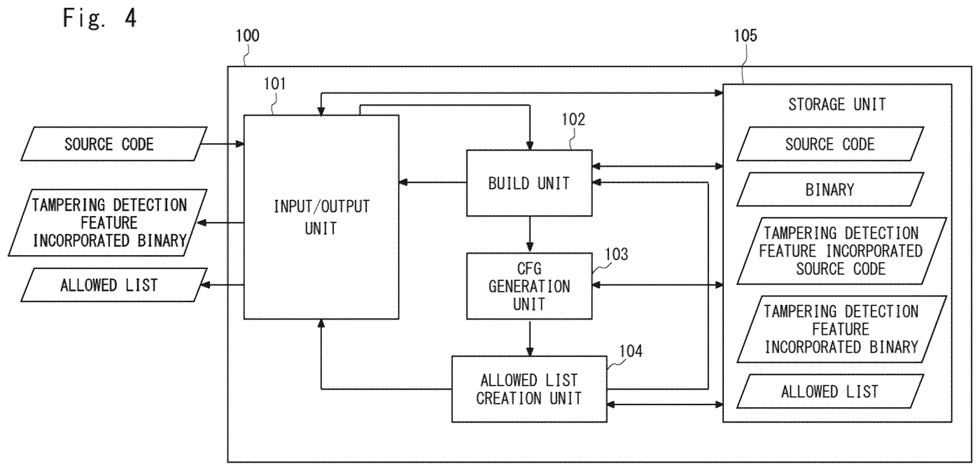

Referring now to FIG. 5, a specific example of a method for determining the part into which the hook is incorporated and the monitoring area of this hook in the allowed list creation unit 104 will be described.

In FIG. 5, the upper stage shows the temporarily-determined monitoring areas, and the lower stage shows the monitoring areas finally determined.

Further, in the upper stage of FIG. 5, monitoring 1 to 4 respectively indicate, for example, the temporarily-determined monitoring areas of the hooks H1 to H4, and processing 1 to 4 respectively indicate processing performed by software.

Referring to the upper stage of FIG. 5, the size of the temporarily-determined monitoring area of the hook H2 is equal to or smaller than a threshold size derived from the allowable processing delay. Further, even if it is assumed that the temporarily-determined monitoring area of the hook H3 is added to the temporarily-determined monitoring area of the hook H2, the total size of the monitoring area after the addition is equal to or smaller than the threshold size.

Therefore, as shown in the lower stage of FIG. 5, the allowed list creation unit 104 adds the temporarily-determined monitoring area of the hook H3 to the temporarily-determined monitoring area of the hook H2, and determines the monitoring area after the addition to be the monitoring area of the hook H2. In accordance therewith, the allowed list creation unit 104 determines to delete the hook H3. In this manner, the monitoring areas are grouped in such a way that the size of each group does not exceed the threshold size derived from the allowable processing delay, whereby it is possible to prevent the processing delay of tampering detection processing from increasing beyond the allowable processing delay while reducing the size of the allowed list.

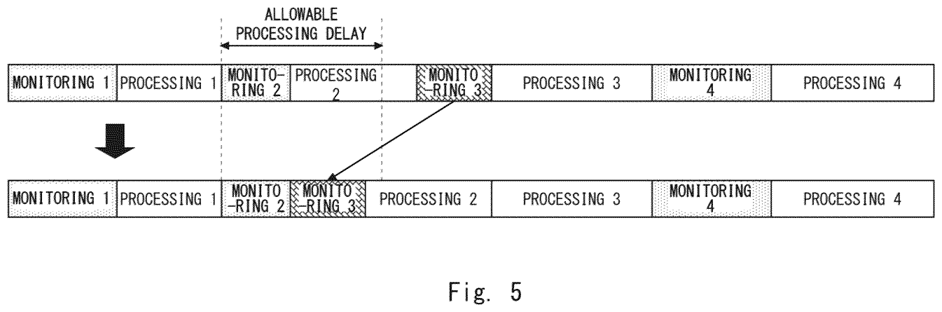

Next, in the following, with reference to FIG. 6, an example of the predetermined policy which is used to determine the monitoring area of the hook in the allowed list creation unit 104 will be described.

According to the basic idea of the predetermined policy, for a certain hook, a node that may be executed next to the temporarily-determined monitoring area is monitored by this hook, and for a node that is located at the branch destination from the temporarily-determined monitoring area and may not be executed, monitoring by this hook is omitted as much as possible.

The allowed list creation unit 104 determines the monitoring area of the hook in accordance with the following priorities so as to follow the aforementioned predetermined policy.

### First Priority (High):

When there is a conditional branch from the temporarily-determined monitoring area regarding a certain hook, one of nodes at the branch destination is definitely executed next.

When there is a conditional branch from the temporarily-determined monitoring area regarding a certain hook, the allowed list creation unit 104 adds all the nodes at the branch destination to the temporarily-determined monitoring Accordingly, in the temporarily-determined monitoring area, a percentage area. of the number of nodes at the branch destination, that is, the percentage of the number of nodes that may be executed next, becomes large.

### Second Priority (Low):

When there is no conditional branch from the temporarily-determined monitoring area regarding a certain hook, the subsequent nodes are definitely executed.

When there is no conditional branch from the temporarily-determined monitoring area regarding a certain hook, the allowed list creation unit 104 adds all the subsequent nodes to the temporarily-determined monitoring area.

FIG. 6 shows an example in which the monitoring area of the hook incorporated just before the node A is determined. In this example, it is assumed that the temporarily-determined monitoring area of this hook is a node A. Further, the node A has conditional branches.

In this case, the allowed list creation unit 104 adds all the nodes B and E at the branch destination to the temporarily-determined monitoring area of this hook (node A) according to the first priority. In this case, while the effect of reducing the size of the allowed list is small, the size of the area where monitoring is wasted becomes small and the number of times of monitoring is reduced.

However, if the nodes B and E are added to the temporarily-determined monitoring area of this hook (node A), the total size of the monitoring area after the addition may become equal to or larger than a threshold size. In this example, it is assumed that the size of the node B is smaller than the size of the node E. It is further assumed that, if nodes B and E are added to the temporarily-determined monitoring area (node A), the total size of the monitoring area after the addition exceeds a threshold size, but if only the node B is added, the total size of the monitoring area is equal to or smaller than the threshold size. Further, there are no conditional branches for the nodes B to D.

In this case, the allowed list creation unit 104 adds not only the node B at the branch destination but also nodes C and D sequentially to the temporarily-determined monitoring area of this hook (node A) according to the second priority if the total size of the monitoring area does not exceed the threshold value. In this case, if the node A is branched off to the node E, the effect of reducing the size of the allowed list becomes large although the size of the area where monitoring is wasted becomes large.

### Operation in First Example Embodiment

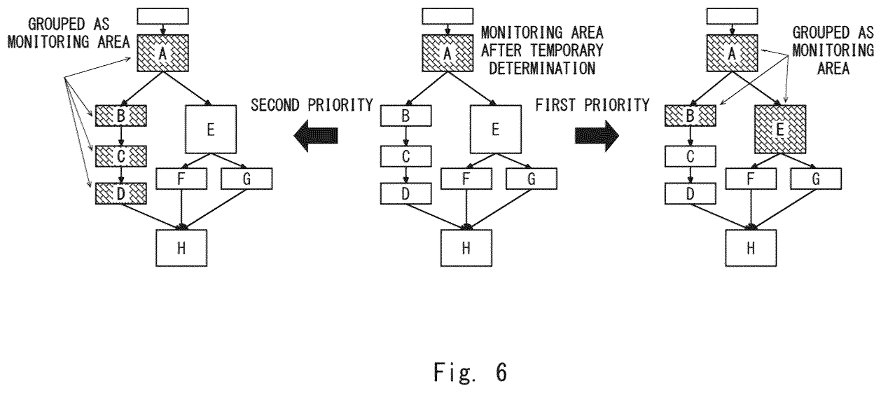

Next, with reference to a flowchart in FIG. 7, an overall operation example of the monitoring area determination apparatus 100 according to the first example embodiment will be described.

Referring to FIG. 7, first, a source code of software to be monitored is input to the input/output unit 101. The input/output unit 101 causes the storage unit 105 to store the input source code and sends a notification to the build unit 102 to cause the build unit 102 to perform processing (Step A1).

Upon receiving the notification from the input/output unit 101, the build unit 102 reads out the source code input in Step A1 from the storage unit 105, builds the source code that has been read out, and generates a binary. The build unit 102 causes the storage unit 105 to store the generated binary and sends a notification to the CFG generation unit 103 to cause the CFG generation unit 103 to perform processing (Step A2).

Upon receiving the notification from the build unit 102, the CFG generation unit 103 reads out the binary generated in Step A2 from the storage unit 105, analyzes the binary that has been read out, and generates a CFG. The CFG generation unit 103 further sends the generated CFG to the allowed list creation unit 104 (Step A3).

Upon receiving the CFG generated in Step A3 from the CFG generation unit 103, the allowed list creation unit 104 determines, for each hook incorporated into the source code, the part of the source code into which this hook is incorporated based on the received CFG, and determines the monitoring area of this hook (Step A4). Note that the details of Step A4 will be described later.

Further, the allowed list creation unit 104 incorporates the hooks into the parts of the source code determined above and incorporates the tampering detection feature into the source code. Accordingly, the allowed list creation unit 104 generates a tampering detection feature incorporated source code into which hooks and the tampering detection feature are incorporated. The allowed list creation unit 104 causes the storage unit 105 to store the tampering detection feature incorporated source code (Step A5). Further, after the processing in Step A5 is ended, the allowed list creation unit 104 sends a notification to the build unit 102 to cause the build unit 102 to perform processing.

Upon receiving the notification from the allowed list creation unit 104, the build unit 102 reads out the tampering detection feature incorporated source code generated in Step A5 from the storage unit 105, builds the tampering detection feature incorporated source code that has been read out, and generates a tampering detection feature incorporated binary. The build unit 102 causes the storage unit 105 to store the generated tampering detection feature incorporated binary (Step A6).

Further, the allowed list creation unit 104 creates, for each hook, an allowed list in which a set of an ID of this hook, a monitoring area of this hook, and a hash value of this monitoring area are registered, and causes the storage unit 105 to store the allowed list that has been created (Step A7). Further, after the processing in Step A7 is ended, the allowed list creation unit 104 sends a notification to the input/output unit 101 to cause the input/output unit 101 to perform processing.

Upon receiving the notification from the allowed list creation unit 104, the input/output unit 101 reads out the allowed list created in Step A7 and the tampering detection feature incorporated binary generated in Step A6 from the storage unit 105, and outputs the allowed list and the tampering detection feature incorporated binary that have been read out (Step A8).

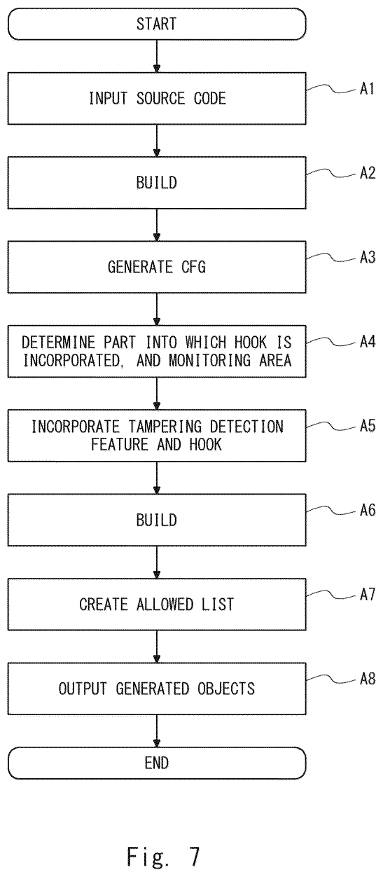

Referring next to a flowchart in FIG. 8, an operation performed by the allowed list creation unit 104 in Step A4 in FIG. 7 will be described in detail.

With reference to FIG. 8, first, the allowed list creation unit 104 temporarily determines, for each hook incorporated into the source code, the part into which this hook is incorporated based on the CFG, and temporarily determines the monitoring area of this hook in accordance with a predetermined rule based on the CFG (Step B1).

Next, the allowed list creation unit 104 determines whether or not there are hooks that have not yet been processed (Step B2). The hooks that have not yet been processed are hooks except for hooks whose monitoring areas are determined in the subsequent Step B4 and hooks determined to be deleted.

When it is determined in Step B2 that there are hooks that have not yet been processed (YES in Step B2), the allowed list creation unit 104 selects one of the hooks that have not yet been processed (Step B3).

Next, the allowed list creation unit 104 determines the monitoring area of this hook selected in Step B3 (Step B4). Specifically, the allowed list creation unit 104 attempts to add, for this hook, one or more nodes to the monitoring area temporarily determined in Step B1 in such a way that the size of the monitoring area does not exceed the threshold size. When a node has been successfully added, the allowed list creation unit 104 determines the monitoring area where the node is added to be the monitoring area of this hook. On the other hand, when a node has not been successfully added, the allowed list creation unit 104 determines the monitoring area temporarily determined in Step B1 to be the monitoring area of this hook. Although there is no need to actually incorporate a hook onto a binary when the monitoring area of each hook is determined, the hook may be incorporated once if it is technically necessary. Note that the details of Step B4 will be described later. Further, when a node is added to the monitoring area of this hook in Step B4, the allowed list creation unit 104 determines to delete the temporarily-determined hook to monitor the added node. Then the process returns to Step B2. As described above, the hook whose monitoring area is determined in Step B4 and a hook that has been determined to be deleted will not be treated as hooks that have not yet been processed in the subsequent Step B2.

On the other hand, when there are no hooks that have not yet been processed in Step B2 (NO in Step B2), the allowed list creation unit 104 determines (establishes) the parts into which the respective hooks are incorporated and the monitoring areas of the respective hooks (Step B5). Specifically, the allowed list creation unit 104 determines (establishes) the parts into which the respective hooks are incorporated and the monitoring areas of the respective hooks that are left without being deleted in the process of Steps B1 to B4. At this time, the allowed list creation unit 104 determines (establishes) the parts into which the respective hooks are incorporated to be the incorporated parts that have been temporarily determined in Step B1 and have not been deleted in Step B4. Further, the allowed list creation unit 104 determines (establishes) the monitoring area of each hook to be the monitoring area determined in Step B4.

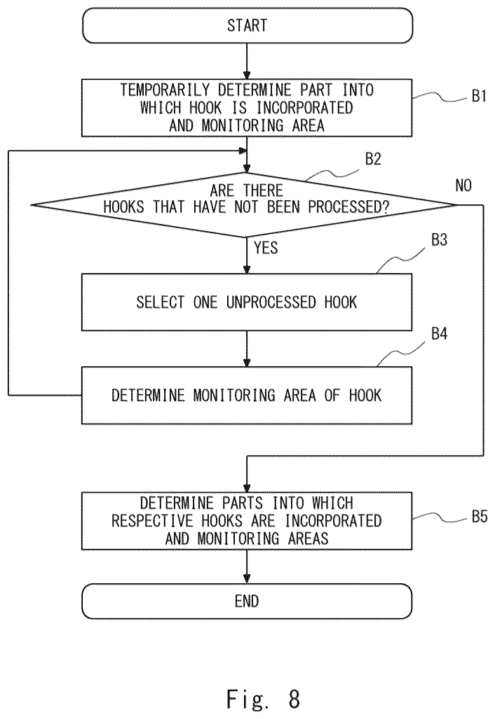

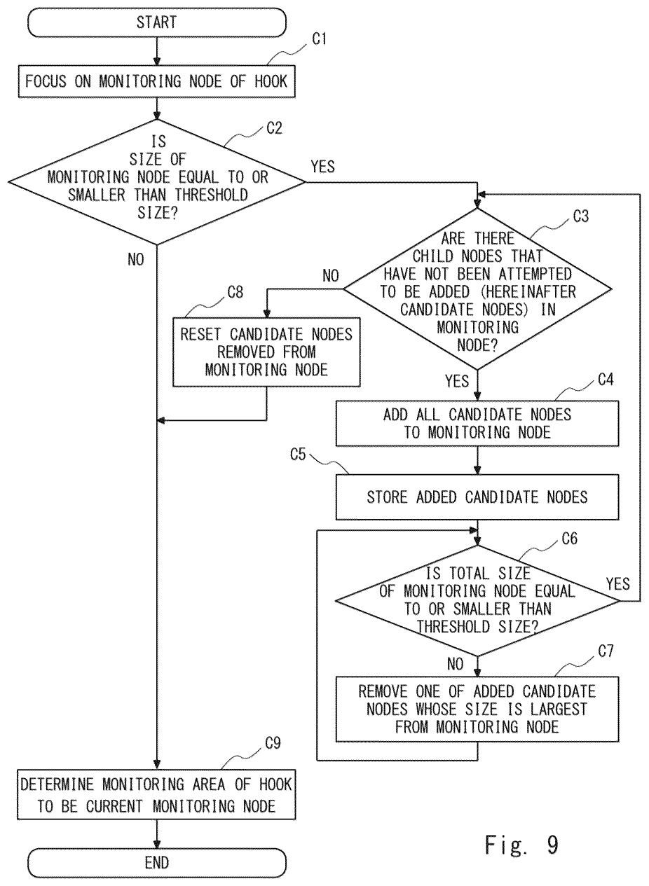

Referring next to a flowchart in FIG. 9, an operation performed by the allowed list creation unit 104 in Step B4 in FIG. 8 will be described in detail. In this example, nodes included in the monitoring areas of the respective hooks are regarded as a group of nodes, which will be hereinafter referred to as a monitoring node. When, for example, the parts into which the respective hooks H1, H2, H4, H5, and H6 are incorporated and the monitoring areas of the respective hooks H1, H2, H4, H5, and H6 have been temporarily determined, like in the examples shown in FIGS. 2 and 3, the monitoring nodes of the respective hooks H1, H2, H4, H5, and H6 are as shown in FIG. 10. Although there is no need to actually incorporate a hook onto a binary when a monitoring node is created, the hook may be incorporated once if it is technically necessary. Further, in a case of normal nodes, the number of child nodes is two if there is a conditional branch, and the number of child nodes is one if there is no conditional branch. On the other hand, the number of child nodes of the monitoring node may be three or larger.

Referring to FIG. 9, first, the allowed list creation unit 104 focuses on the temporarily determined monitoring node of the hook selected in Step B3 in FIG. 8 (Step C1). Note that nodes included in monitoring node of this hook are stored in the storage unit 105 at an arbitrary timing such as a timing after the processing of Step B1 in FIG. 8 is ended. In the example in which the hook H1 in FIG. 10 is selected as this hook, the monitoring node of the hook H1 includes nodes 1 and 3.

Next, the allowed list creation unit 104 determines whether or not the size of the monitoring node of this hook is equal to or smaller than the threshold size derived from the predetermined allowable processing delay (Step C2).

When the size of the monitoring node of this hook exceeds the threshold size in Step C2 (NO in Step C2), the allowed list creation unit 104 determines the monitoring area of this hook to be the current monitoring node of this hook (Step C9).

On the other hand, when the size of the monitoring node of this hook is equal to or smaller than the threshold size in Step C2 (YES in Step C2), the allowed list creation unit 104 determines whether or not there are child nodes that have not been attempted to be added (hereinafter they are referred to as “candidate nodes”) in the monitoring node of this hook (Step C3). In the example in which the hook H1 shown in FIG. 10 is selected as this hook, the candidate nodes in the monitoring node of the hook H1 are three nodes 2, 4, and 5.

In Step C3, when there are candidate nodes that have not been attempted to be added to the monitoring node of this hook (YES in Step C3), the allowed list creation unit 104 adds, to the monitoring node of this hook, all the candidate nodes that have not been attempted to be added (Step C4), and causes the added candidate nodes to be stored in the storage unit 105 (Step C5). In the example in which the hook H1 in FIG. 10 is selected as this hook, if no attempt is made to add the nodes 2, 4, and 5, which are candidate nodes, the allowed list creation unit 104 adds all the nodes 2, 4, and 5 to the monitoring node of the hook H1.

Next, the allowed list creation unit 104 determines whether or not the total size after the candidate nodes are added to the monitoring node of this hook is equal to or smaller than the threshold size (Step C6).

When the total size of the monitoring node of this hook exceeds the threshold size in Step C6 (NO in Step C6), the allowed list creation unit 104 removes one of the candidate nodes added in Step C4 whose size is the largest from the monitoring node of the hook (Step C7), and then the process returns to the processing in Step C6.

On the other hand, when the total size of the monitoring node of this hook is equal to or smaller than the threshold size in Step C6 (YES in Step C6), the process returns to the processing in Step C3.

That is, in Steps C6 and C7, the allowed list creation unit 104 performs processing for removing the candidate nodes added in Step C4 from the monitoring node of this hook in an order of decreasing the size until the total size of the monitoring node of this hook becomes equal to or smaller than the threshold size. In the example in which the hook H1 in FIG. 10 is selected as the hook, when nodes 2, 4, and 5 are added to the monitoring node of the hook H1 in Step C4, the allowed list creation unit 104 removes the nodes 2, 4, and 5 from the monitoring node of the hook H1 in an order of descending the size. As a result, in the monitoring node of the hook H1, at least one of the nodes 2, 4, and 5 is held to be added or all the nodes 2, 4, and 5 are removed.

In Step C3 after the step returns from Step C6, when there is a node that is added to the monitoring node of this hook, the allowed list creation unit 104 determines whether or not there are candidate nodes that have not been attempted to be added in the monitoring node in this state. In the example in which the hook H1 shown in FIG. 10 is selected as this hook, when, for example, the node 2 is added to the monitoring node of the hook H1, a new candidate node in the monitoring node of the hook H1 is a node 6. Therefore, in the subsequent processing from Steps C4 to C7, the allowed list creation unit 104 adds the node 6 to the monitoring node of the hook H1. Then, when the total size of the monitoring node of the hook H1 is equal to or smaller than the threshold size, the node 6 is held to be added, whereas, when the total size exceeds the threshold size, the node 6 is removed.

When there is no candidate node that has not been attempted to be added to the monitoring node of this hook in Step C3 (NO in Step C3), the allowed list creation unit 104 resets the candidate nodes removed from the monitoring node of this hook in Step C7 and deletes them from the storage unit 105 (Step C8). After that, the allowed list creation unit 104 determines the monitoring area of this hook to be the current monitoring node of this hook (Step C9).

### Effects of First Example Embodiment

Next, effects of the monitoring area determination apparatus 100 according to the first example embodiment will be described.

According to the above first example embodiment, the allowed list creation unit 104 temporarily determines, based on the CFG, a part where a hook is incorporated, and temporarily determines the monitoring area of this hook. Next, the allowed list creation unit 104 sequentially selects the hook whose incorporated part has been temporarily determined, and adds a node to the temporarily-determined monitoring area of the selected hook based on a predetermined allowable processing delay. After that, the allowed list creation unit 104 determines the monitoring area after the node is added to the temporarily-determined monitoring area of this hook to be the monitoring area of this hook. Accordingly, it is possible to add nodes to the monitoring areas of the respective hooks in consideration of the allowable processing delay. Accordingly, it is possible to prevent the processing delay of tampering detection processing from increasing beyond the allowable processing delay while reducing the size of the allowed list by grouping the monitoring areas and to determine the monitoring areas of the hooks in such a way that the monitoring area falls within an appropriate range.

Further, according to the first example embodiment, the allowed list creation unit 104 selects a node to be added to the temporarily-determined monitoring area in such a way that the percentage of the number of nodes that may be executed next becomes larger in the temporarily-determined monitoring area. That is, the allowed list creation unit 104 selects, when there is a conditional branch in the temporarily-determined monitoring area, nodes at the branch destination that may be executed next, and adds the selected nodes to the temporarily-determined monitoring area. Accordingly, it is possible to add nodes to the monitoring areas of the respective hooks so as to prevent the memory area that is not executed on software from being monitored unnecessarily. Accordingly, it is possible to determine the monitoring areas of the hooks in such a way that the number of times of monitoring becomes small while reducing the size of the allowed list.

### Second Example Embodiment

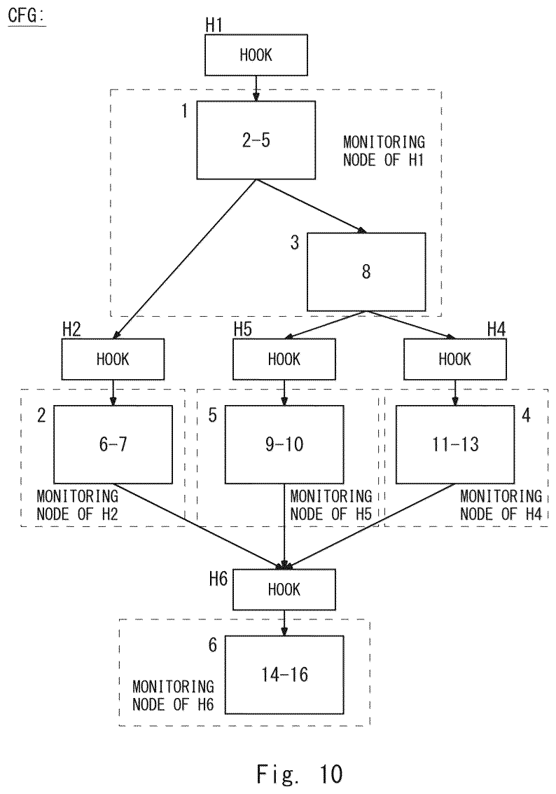

Next, with reference to FIG. 11, a configuration example of a monitoring area determination apparatus 200 according to a second example embodiment will be described. This second example embodiment is a higher concept of the above-described example embodiment.

Referring to FIG. 11, the monitoring area determination apparatus 200 according to the second example embodiment includes a CFG generation unit 201 and a monitoring area determination unit 202.

The CFG generation unit 201 generates a CFG based on a binary of software to be monitored. The CFG generation unit 201 corresponds to the CFG generation unit 103 according to the above-described first example embodiment.

The monitoring area determination unit 202 temporarily determines, based on the CFG, the part in which the hook is incorporated into the source code of the software to be monitored, and temporarily determines, based on the CFG, the monitoring area of the hook whose incorporated part is temporarily determined in accordance with a predetermined rule, and sequentially selects the hook whose incorporated part has been temporarily determined. Then, the monitoring area determination unit 202 adds a node to the temporarily-determined monitoring area of the selected hook based on a predetermined allowable processing delay, and determines the monitoring area after the node is added to the temporarily-determined monitoring area of the selected hook to be the monitoring area of the selected hook. The monitoring area determination unit 202 corresponds to the allowed list creation unit 104 according to the aforementioned first example embodiment.

According to the second example embodiment, it is possible to add nodes to the monitoring areas of the respective hooks in consideration of the allowable processing delay. Accordingly, it is possible to prevent the processing delay of tampering detection processing from increasing beyond the allowable processing delay while reducing the size of the allowed list by grouping the monitoring areas and to determine the monitoring areas of the hooks in such a way that the monitoring area falls within an appropriate range.

Note that the monitoring area determination unit 202 may add a node to the temporarily-determined monitoring area of the selected hook in such a way that the size of the monitoring area does not exceed the threshold size in accordance with the allowable processing delay.

Further, the monitoring area determination unit 202 may select, in the temporarily-determined monitoring area of the selected hook, a node to be added to the monitoring area in such a way that the percentage of the nodes that may be executed next to the node included in this monitoring area becomes large.

Further, the monitoring area determination unit 202 may determine to delete, of the hooks whose incorporated parts are temporarily determined, a hook temporarily determined to monitor the node added to the temporarily-determined monitoring area of the selected hook.

Further, the predetermined rule may be a rule in which, of all the descendant nodes of the node including the target hook whose incorporated part has been temporarily determined, nodes that do not include hooks are traced and nodes from the node including the target hook to a node just before the node including the next hook are added to the monitoring area of the target hook.

Further, the predetermined rule may be a rule in which the node including the target hook whose incorporated part is temporarily determined is added to the monitoring area of the target hook.

Further, the tampering detection feature may be an allowed-list-type tampering detection feature created as a list of hash values of monitoring areas of hooks.

### Third Example Embodiment

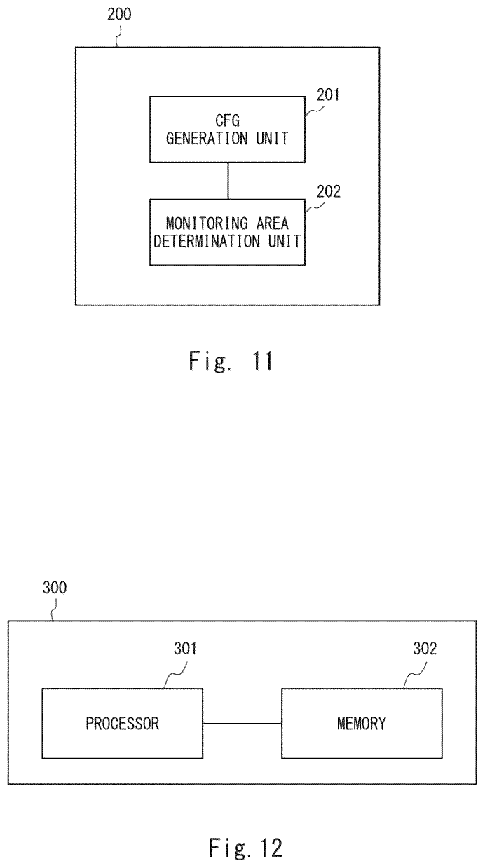

Referring next to FIG. 12, a hardware configuration example of a monitoring area determination apparatus 300 according to a third example embodiment will be described.

Referring to FIG. 12, the monitoring area determination apparatus 300 according to the third example embodiment includes a processor 301 and a memory 302.

The processor 301 may be, for example, a microprocessor, a Micro Processing Unit (MPU), or a Central Processing Unit (CPU). The processor 301 may include a plurality of processors.

The memory 302 is composed of a combination of a volatile memory and a non-volatile memory. The memory 302 may include a storage that is located apart from the processor 301. In this case, the processor 301 may access the memory 302 via an Input (I)/Output (O) interface.

The monitoring area determination apparatuses 100 and 200 according to the above-described first and second example embodiments may include the hardware configuration shown in FIG. 12. The memory 302 stores a program. This program includes instructions (or software codes) that, when loaded into a computer, cause the computer to perform one or more of the functions described in the above-described first and second example embodiments. The input/output unit 101, the build unit 102, the CFG generation units 103 and 201, the allowed list creation unit 104, and the monitoring area determination unit 202 in the above-described monitoring area determination apparatuses 100 and 200 may be implemented by the processor 301 loading a program stored in the memory 302 and executing the loaded program. Further, the storage unit 105 in the above-described monitoring area determination apparatus 100 may be implemented by the memory 302.

Further, the above-described program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been described above with reference to the example embodiments, the present disclosure is not limited to the aforementioned example embodiments. Various changes that may be understood by those skilled in the art within the scope of the present disclosure may be made to the configurations and the details of the present disclosure.

For example, there is a case where the size of a single node exceeds a threshold size derived from a predetermined allowable processing delay. In this case, even when the part into which the hook is incorporated is temporarily determined to be the top of the node or the like and the monitoring area of this hook is temporarily determined to be only this node, the processing delay of tampering detection processing increases beyond the allowable processing delay. When the size of a single node is so large that it exceeds the threshold size, this node may be divided by the threshold size, and the part into which the hook is incorporated and its monitoring area may be temporarily determined.

### REFERENCE SIGNS LIST

100 MONITORING AREA DETERMINATION APPARATUS
101 INPUT/OUTPUT UNIT
102 BUILD UNIT
103 CFG GENERATION UNIT
104 ALLOWED LIST CREATION UNIT
105 STORAGE UNIT
200 MONITORING AREA DETERMINATION APPARATUS
201 CFG GENERATION UNIT
202 MONITORING AREA DETERMINATION UNIT
300 MONITORING AREA DETERMINATION APPARATUS
301 PROCESSOR
302 MEMORY

What is claimed is:

1. A monitoring area determination apparatus configured to determine, for software to be monitored, a monitoring area of a tampering detection feature call function incorporated together with a tampering detection feature, the monitoring area determination apparatus comprising:
at least one memory storing instructions, and
at least one processor configured to execute the instructions to;
generate a control flow graph (CFG) based on a binary of the software,
temporarily determine, based on the CFG, a part of a source code of the software into which the tampering detection feature call function is incorporated, and temporarily determine, in accordance with a predetermined rule, based on the CFG, a monitoring area of the tampering detection feature call function whose incorporated part is temporarily determined,
sequentially select the tampering detection feature call function whose incorporated part has been temporarily determined,
add a node to the temporarily-determined monitoring area of the selected tampering detection feature call function based on a predetermined allowable processing delay, and
determine, as a monitoring area of the selected tampering detection feature call function, a monitoring area after the node is added to the temporarily-determined monitoring area of the selected tampering detection feature call function.

2. The monitoring area determination apparatus according to claim 1, wherein the at least one processor is further configured to execute the instructions to add a node to the temporarily-determined monitoring area of the selected tampering detection feature call function in such a way that the size of the monitoring area does not exceed a threshold size in accordance with the allowable processing delay.

3. The monitoring area determination apparatus according to claim 1, wherein the at least one processor is further configured to execute the instructions to select a node to be added to the monitoring area in such a way that, in the temporarily-determined monitoring area of the selected tampering detection feature call function, a percentage of the number of nodes that may be executed next to the node included in this monitoring area becomes large.

4. The monitoring area determination apparatus according claim 1, wherein the at least one processor is further configured to execute the instructions to determine to delete, of the tampering detection feature call functions whose incorporated parts have been temporarily determined, the tampering detection feature call function temporarily determined to monitor a node added to the temporarily-determined monitoring area of the selected tampering detection feature call function.

5. The monitoring area determination apparatus according to claim 1, wherein the predetermined rule is a rule in which, of all descendant nodes of the node including the target tampering detection feature call function whose incorporated part is temporarily determined, nodes that do not include the tampering detection feature call function are traced, and nodes from a node including the target tampering detection feature call function to a node just before a node including the next tampering detection feature call function are added to the monitoring area of the target tampering detection feature call function.

6. The monitoring area determination apparatus according to claim 1, wherein the predetermined rule is a rule in which a node including the target tampering detection feature call function whose incorporated part is temporarily determined is added to the monitoring area of the target tampering detection feature call function.

7. The monitoring area determination apparatus according to claim 1, wherein the tampering detection feature is an allowed-list-type tampering detection feature created as a list of a hash value of the monitoring area of the tampering detection feature call function.

8. A monitoring area determination method executed by a monitoring area determination apparatus configured to determine, for software to be monitored, a monitoring area of a tampering detection feature call function incorporated together with a tampering detection feature, the monitoring area determination method comprising the steps of:
generating a control flow graph (CFG) based on a binary of the software;
temporarily determining, based on the CFG, a part of a source code of the software into which the tampering detection feature call function is incorporated and temporarily determining, in accordance with a predetermined rule, based on the CFG, a monitoring area of the tampering detection feature call function whose incorporated part is temporarily determined;
sequentially selecting the tampering detection feature call function whose incorporated part has been temporarily determined;
adding a node to the temporarily-determined monitoring area of the selected tampering detection feature call function based on a predetermined allowable processing delay; and
determining, as a monitoring area of the selected tampering detection feature call function, a monitoring area after the node is added to the temporarily-determined monitoring area of the selected tampering detection feature call function.

9. A non-transitory computer readable medium storing a program causing a computer to execute processing for determining, for software to be monitored, a monitoring area of a tampering detection feature call function incorporated together with a tampering detection feature, wherein the program comprises the steps of:
generating a control flow graph (CFG) based on a binary of the software;
temporarily determining, based on the CFG, a part of a source code of the software into which the tampering detection feature call function is incorporated and temporarily determining, in accordance with a predetermined rule, based on the CFG, a monitoring area of the tampering detection feature call function whose incorporated part is temporarily determined;
sequentially selecting the tampering detection feature call function whose incorporated part has been temporarily determined;
adding a node to the temporarily-determined monitoring area of the selected tampering detection feature call function based on a predetermined allowable processing delay; and
determining, as a monitoring area of the selected tampering detection feature call function, a monitoring area after the node is added to the temporarily-determined monitoring area of the selected tampering detection feature call function.
